(19) United States
(12) Patent Application Publication
(10) Pub. No.: US 2005/0023771 A1
(43) Pub. Date: Feb. 3, 2005

(54) Trim for sealing joints against water penetration

(76) Inventor: Tara Chand Singhal, Torrance, CA (US)

Correspondence Address: Tara Chand Singhal, P. O. Box 5075, Torrance, CA, 90510, US

(21) Appl. No.: 10/797,275

(22) Filed: Mar. 11, 2004

Related U.S. Application Data
(63) Continuation-in-part of application No. 09/246,061, filed on Feb. 8, 1999, now abandoned.

(51) Int. Cl. F16J 15/02

(52) U.S. Cl. 277/628

(57) ABSTRACT

A trim for sealing joints between a horizontal surface and a vertical surface against water penetration has an elongated body with a front-side and a back-side. The front-side has a curvature having a convex part and a concave part that together forming a continuous curvature to channel the flow of water away from the joint. The back-side has at least two recesses for an adhesive-sealant application, where the first recess is used for adhering to the vertical wall and the second is used adhering to the joint. The trim can be made of ceramic or plastic.

### CROSS REFERENCE TO RELATED APPLICATIONS

This application is a continuation-in-part of U.S. patent application Ser. No. 09/246,061 filed Jun. 12, 2001, titled “A Trim for Sealing Joints against Water Penetration”, of Tara Chand Singhal. This application claims priority on the application Ser. No. 09/246,061 and is incorporated herein by reference.

### FIELD OF THE INVENTION

The present invention is directed to a method and apparatus for a trim for sealing joints against water penetration in applications such as in bathroom between a wall and a bath-tub.

### BACKGROUND

Sealing of wall and bath-tub joints has always been a problem. Traditional method is to fill the space at the joint with grout and then apply silicon caulk over the joint. This method of sealing the joint always gives trouble after some time.

The caulk deteriorates, becomes yellow and moldy and develops hairline cracks from being exposed to the water. The bathtub flexes up and down a little from the weight of a person causing hairline cracks in the grout. Combination of these factors makes the seal of the joint ineffective. This allows water to penetrate and cause damage to the underlying structure. There is also the factor of aesthetics as the joint always looks dirty and unsightly from the constant re-caulking that it requires and is hard to keep clean.

U.S. Pat. No. 5,287,667, titled “Water Proof Tile for Tub and Tile Corners” disclosed a solution by use of a tile trim that is the last tile on the tile wall. This trim is part of the tile wall and needs to be installed with the rest of the tiles.

Therefore, it is an object of the present invention to have a trim that can be installed on top of the existing wall surface in a bath-tub and effectively seal the joint between the bath-tub and the wall against water penetration.

### SUMMARY

This invention discloses a trim that seals the joint against both the vertical water flow and the horizontal water flow penetration. The trim has an elongated body with a front-side that is smooth and finished and a back-side that is rough or unfinished. The front-side has a curvature to channel the flow of water away from the wall into the tub and away from the joint. The back-side of the trim has at least two recesses, which hold an adhesive-sealant.

A method of installation of the trim requires, first laying a bead of the adhesive-sealant, at the joint and applying the same adhesive-sealant to the back-side, and then attaching the trim in place against the vertical surface.

### BRIEF DESCRIPTION OF THE DRAWINGS

These and other features, aspects and advantages of the present invention will become better understood with regard to the following description, appended claims and accompanying drawings where:

FIG. 1 shows a version of the perspective view of the trim;

FIG. 2A shows a version of the side view of the trim;

FIG. 2B shows a version of the top views of a 45 degree bevel trim; and

FIG. 3 shows a version of the method of installation.

### DESCRIPTION

A trim for sealing joints between a horizontal surface and a vertical surface against water penetration is described. The preferred embodiment is in sealing wall and bath-tub/shower-pan joint. The trim is preferably, made of ceramic. The glazed side of a ceramic trim is impervious to water. The trim may alternatively may also be made of plastic, as plastic is also impervious to water.

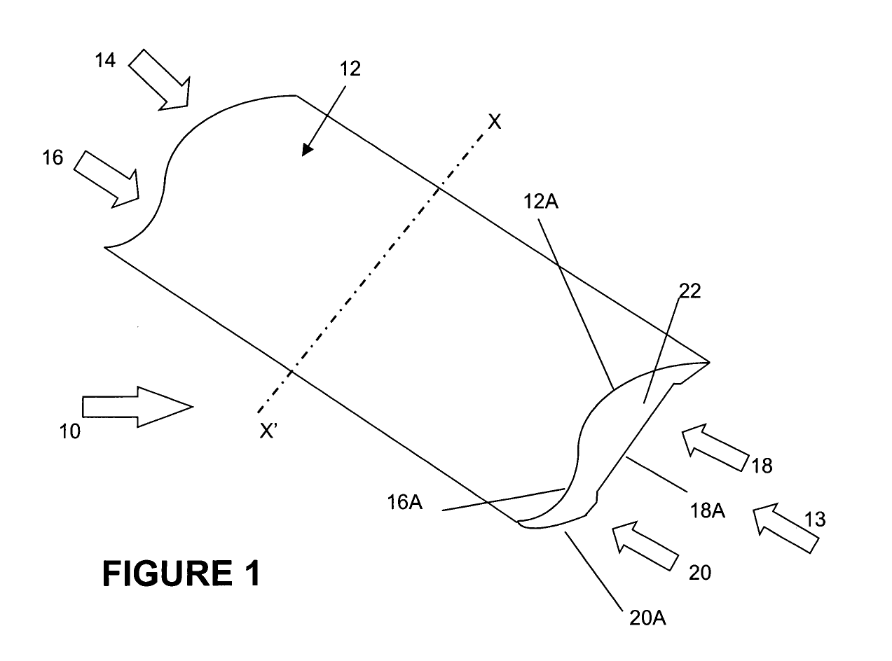

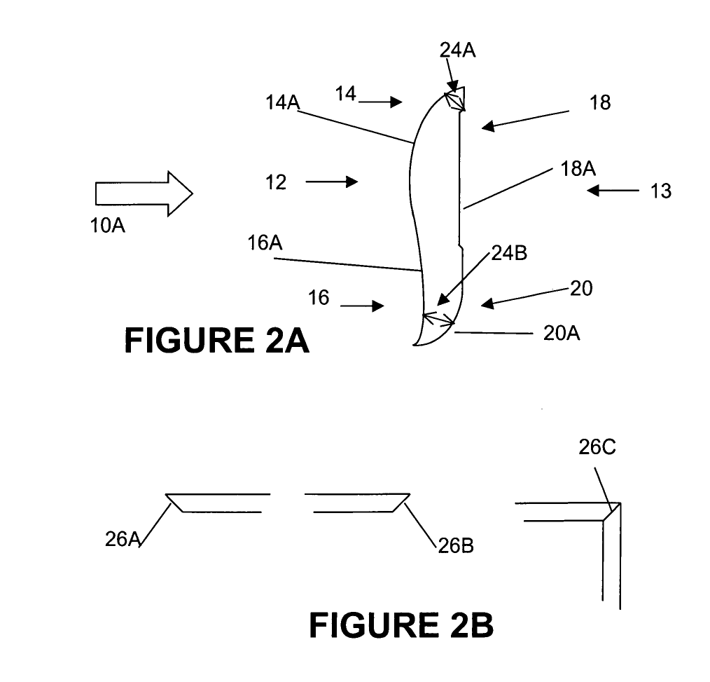

FIG. 1 illustrates a perspective view (10) of the trim and FIG. 2A illustrates a cross section along X-X′ view (10A). The trim is an elongated body (10) with a front-side (12) and a back-side (13). The front-side (12) has a top-front-side (14) and a bottom-front-side (16). The top-front-side (14) is made up of a convex curvature (14A), and the bottom-front-side (16) is made up of a concave curvature (16A), wherein the convex and the concave curvatures are joined together to form a continuous S-shape curvature.

The back-side (13) has a top-back-side (18) and a bottom-back-side (20). The top-back-side (18) has a recess (18A), for holding an adhesive-sealant, which will adhere and seal the trim to the vertical surface and protect the joint against the vertical water penetration. The bottom-back-side (20) has a recess (20A), for holding the adhesive-sealant, which will seal and adhere the trim to the tub/wall joint and protect the joint from horizontal water flow penetration.

As shown in FIG. 2A, the top-front-side (14) joins the top-back-side (18) at an acute angle (24A). Also the bottom-front-side (16) joins the bottom-back-side (20) at an acute angle (24B). The acute angles (24A and 24B) could be substantially 60 degrees. The angles could also be substantially 45 degrees. The angles may be some other suitable acute angle values.

The purpose of the acute angle (24A) and the convex curvature (14A) is to channel the vertical flow of water away from the wall, and the purpose of the acute angle (24B) and the concave curvature (16A) is to channel the flow of water into the tub and away from the tub-tile joint.

The trim body (10) has left flat edge (not shown) and a right flat edges (22) that abut against and are joined with other trim bodies with the same adhesive-sealant. As shown in the simplified illustration, FIG. 2B, the left edge (26A) or the right edge (26B) of the body (10) is beveled at 45 degrees. This 45 degree bevel enables the trim to function as a last piece in an installation. The same 45-degree bevel enables one right bevel edge and one left bevel edge to function as a right angle corner (26C).

With reference to FIG. 1, the trim body (10) with a 45 degree bevel on either the left edge or the right edge (22) of the front-side (12) provides a trim that can be used both as a last trim on an installation as well as to make right angle corners between two trims as illustrated in FIG. 2B.

The adhesive-sealant may be silicon caulk commonly available in hardware stores that has both sealant, adhesive and flexibility properties.

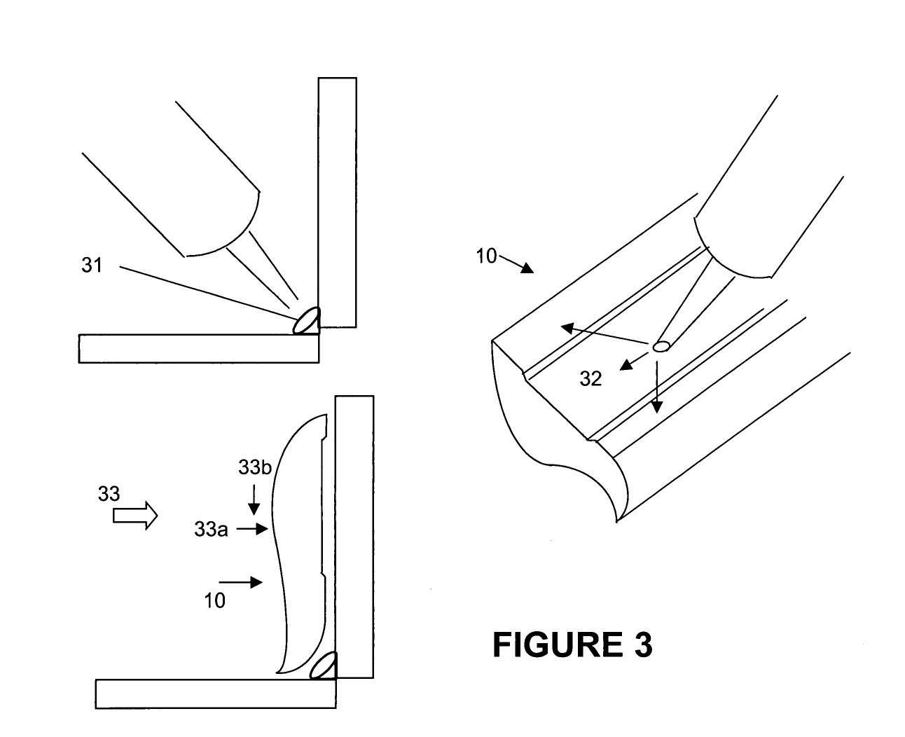

FIG. 3 shows a method of installation. A method of sealing joint using this trim (10) between a vertical surface and a horizontal surface has the following steps.

(a) Lay a bead of adhesive-sealant at the vertical/horizontal surface joint (31).

(b) Apply adhesive-sealant to the backside of the trim. (32)

(c) Position the back-side of the trim against the vertical surface (33) applying horizontal force (33a) and downward force (33b).

The method further includes placing additional trims side by side and sealing the edges of the trim with the same adhesive-sealant. The method also includes positioning 45 degree bevel trims side by side to make a 90 degree angle between the trims. The method also includes positioning a 45 degree bevel trim to make it the last trim.

The trim (10) of this invention seals joints between a horizontal surface and a vertical surface against water penetration. The front-side has a curvature having a convex part and a concave part that together forming a continuous curvature to channel the flow of water away from the joint. The back-side has at least two recesses for an adhesive-sealant application, where the first recess is used for adhering to the vertical wall and the second is used adhering to the joint. The trim can be made of ceramic or plastic.

Although the present invention has been described in considerable detail with respect to certain preferred versions thereof, other versions are possible. Therefore, the spirit and scope of the appended claims should not be limited to the descriptions of the preferred versions contained herein.

1. A trim for sealing a joint between a vertical and a horizontal surface against water penetration comprising:
(a) an elongated trim with front-side and a back-side, the front-side having a top-front-side and a bottom-front-side and the back-side having a top-back-side and a bottom-back-side;
(b) the top-front-side having a convex curvature and the bottom-front-side having a concave curvature, wherein the convex and concave curvatures form a continuous S-shape curvature;
(c) the top-front-side joining the top-back-side at an acute angle and the bottom-front-side joining the bottom-back-side also at an acute angle;
(d) the top-back-side having a plurality of recesses for holding an adhesive-sealant compound, wherein the top-backside can be affixed to the vertical surface of the joint;
(e) the bottom-back-side having a recess for holding an adhesive-sealant compound, wherein the bottom-back-side can be affixed to the joint between the vertical and horizontal surfaces.

2. The claim as in 1, wherein the front-side is glazed and the back-side is un-glazed, when the trim is made of ceramic.

3. The claim as in 1, wherein the trim is installed at a joint between a wall and a tub, without visible caulk that is exposed, to channel the flow of water away from the joint.

4. The claim as in 1; wherein the front-side is finished and the back-side is unfinished, when the trim is made of a water impervious material such as plastic.

5. The claim as in 1, wherein, the trim having a flat left-edge and a flat right-edge, for joining a plurality of trims side by side.

6. The claim as in 5, wherein, either the right-edge or the left-edge having a 45 degrees bevel, for joining two trims at a 90 degree angle.

7. The claim as in 5, wherein, either the right-edge or the left-edge having a 45 degree bevel, for it function as a last trim piece.
